(19) United States
(12) Patent Application Publication
(10) Pub. No.: US 2009/0007044 A1
(43) Pub. Date: Jan. 1, 2009

(54) Design support method and apparatus, and computer product

(75) Inventors: Toshiyuki Shibuya, Kawasaki (JP); Katsumi Homma, Kawasaki (JP); Izumi Nitta, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/149,256

(22) Filed: Apr. 29, 2008

(30) Foreign Application Priority Data
Jun. 19, 2007 (JP) 2007-161576

(51) Int. Cl. G06F 17/50

(52) U.S. Cl. 716/10; 716/11

(57) ABSTRACT

A design support apparatus includes an extracting unit that extracts a first cell from among plural cells in a target circuit; a detecting unit that detects a second cell arranged adjacent to the first cell; and a setting unit that sets a delay value of the first cell according to an arrangement pattern of the second cell.

### CROSS-REFERENCE TO RELATED APPLICATIONS

This application is based upon and claims the benefit of priority from the prior Japanese Patent Application No. 2007-161576, filed on Jun. 19, 2007, the entire contents of which are incorporated herein by reference.

### BACKGROUND OF THE INVENTION

1. Field of the Invention

The present invention relates to a technology of supporting design of semiconductor integrated circuits.

2. Description of the Related Art

Recently, along with the miniaturization of semiconductor integrated circuits, effects of variation of process, reduction in power source voltage, crosstalk, etc. are getting greater, and fluctuations of circuit delay are increasing. Although the fluctuations of circuit delay are additionally reserved as a margin in a delay analysis that estimates the circuit delay in semiconductor integrated circuits, the timing design is difficult since the margin increases.

One cause of the fluctuations of circuit delay is shape variation of a transfer pattern due to inability of appropriately transferring a minute pattern shape when transferring a pattern on a silicon wafer in an exposure operation at the time of manufacture. Especially, when transferring a pattern having a size equal to or smaller than an exposure wavelength, it is problematic that a transfer pattern is thinned and discontinued in the worst case due to the proximity effect of light.

Therefore, techniques are disclosed to correct a pattern to be transferred on a silicon wafer in consideration of the proximity effect of light. For example, the techniques include a “hammer head pattern” that preliminarily thickens a portion such as a contour portion of a pattern of which size is to be thinner than an actual size after the transfer, and a “bias” that corrects fluctuations of a line width of a pattern.

A technique is also disclosed to perform timing adjustment after layout design by changing the size of a particular element in a cell within a cell block where a timing error of an input signal occurs (see, e.g., Japanese Patent Application Laid-Open Publication No. 2000-332119). This enables short-TAT timing adjustment to be automatically performed when a timing error occurs without circuit redesign that affects the design TAT and without modifying the layout.

However, according to the above conventional techniques, in the layout design of a design target circuit, cells are characterized under the worst condition based on the assumption that adjacent cells are not present such that the external output is stabilized regardless of arrangement patterns of other cells with respect to each cell in a layout.

As a result, a delay margin becomes excessive, and pessimistic and inaccurate delay analysis is performed. Therefore, the circuit is frequently redesigned, thereby causing increase in a period of time for the verification and the design.

Since cells are also characterized for the leak current under the worst condition, a margin of power consumption is excessive. Therefore, power-source wiring resources and a power source are needlessly required, and the circuit design becomes very difficult, thereby causing increase in the period of time for the verification and the design.

### SUMMARY OF THE INVENTION

It is an object of the present invention to at least solve the above problems in the conventional technologies.

A computer-readable recording medium according to one aspect of the present invention stores therein a design support program causing a computer to execute extracting a first cell from among plural cells in a target circuit; detecting a second cell arranged adjacent to the first cell; and setting a delay value of the first cell according to an arrangement pattern of the second cell.

A computer-readable recording medium according to another aspect of the present invention stores therein design data concerning a target circuit including a dummy transistor arranged in an available area adjacent to a cell including a transistor.

A semiconductor integrated circuit according to still another aspect of the present invention includes a dummy transistor arranged in an area adjacent to a cell including a transistor.

A design support apparatus according to still another aspect of the present invention includes an extracting unit that extracts a first cell from among plural cells in a target circuit; a detecting unit that detects a second cell arranged adjacent to the first cell; and a setting unit that sets a delay value of the first cell according to an arrangement pattern of the second cell.

A design support method according to still another aspect of the present invention includes extracting a first cell from among a plurality of cells in a target circuit; detecting a second cell arranged adjacent to the first cell; and setting a delay value of the first cell according to an arrangement pattern of the second cell.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a worst condition and a best condition when a cell is characterized;

FIG. 2 is a schematic of a design support apparatus according to an embodiment of the present invention;

FIG. 3 is a schematic of arrangement patterns of other cells;

FIG. 4 is a schematic of a cell library;

FIG. 5 is a block diagram of the design support apparatus;

FIG. 6 is a schematic of arrangement information;

FIG. 7 is a flowchart of a design support process executed by the design support apparatus;

FIG. 8 is a first schematic of a layout of the design target circuit;

FIG. 9 is a flowchart of a design support process of the first example;

FIG. 10 is a second schematic of the layout of the design target circuit;

FIG. 11 is a flowchart of a design support process of the second embodiment;

FIG. 12 is a first schematic of a change process executed by a changing unit;

FIG. 13 is a flowchart of a design support process of the third embodiment;

FIG. 14 is a second schematic of the change process performed by the changing unit;

FIG. 15 is a flowchart of a design support process of the fourth embodiment;

FIG. 16 is a schematic illustrating extension of a wiring length caused by a change in an arrangement position;

FIG. 17 is a schematic of the process of arranging a dummy transistor according to presence of a wiring;

FIG. 18 is a schematic of an arrangement position table;

FIG. 19 is a flowchart of a design support process of the sixth embodiment;

FIG. 20 is a third schematic of the layout of the design target circuit;

FIG. 21 is a flowchart of a design support process of the seventh example; and

FIG. 22 is a fourth schematic of the layout of the design target circuit.

### DETAILED DESCRIPTION OF THE PREFERRED EMBODIMENTS

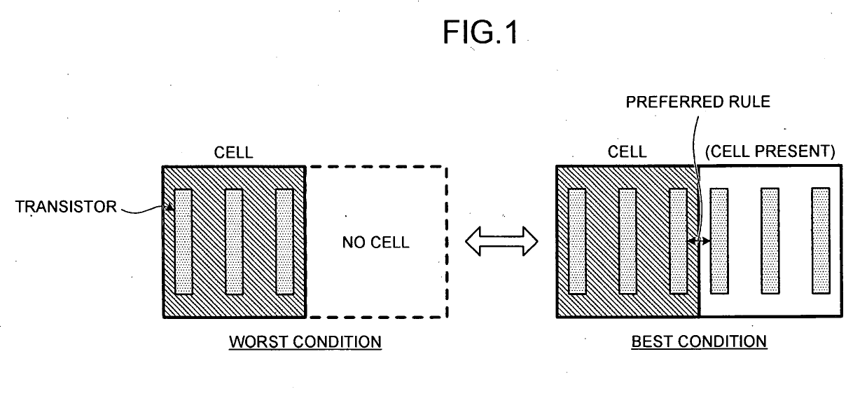

FIG. 1 is a schematic of a worst condition and a best condition when a cell is characterized. The worst condition and the best condition when characterizing a cell including plural transistors are shown in FIG. 1.

The worst condition represents a situation that another cell is not arranged adjacent to a certain cell according to a preferred rule. The preferred rule is a design rule that prescribes an interval between transistors. The best condition represents a situation that another cell is arranged adjacent to a certain cell according to a preferred rule.

Normally, at the time of arrangement/wiring on a layout of a design target circuit, a mask pattern (transfer pattern) can clearly (accurately) be transferred on a silicon wafer in the mask design by regularly arranging transistors according to the preferred rule.

This is because lights transmitted through a photo mask are enhanced through interference with each other by arranging the transistors at intervals defined in the preferred rule, and a minute shape (especially, contour portion) of the mask pattern can accurately be transferred on the silicon wafer. Therefore, shape variation of a mask pattern can be constrained to reduce unnecessary margins of delay and power consumption.

In this embodiment, the unnecessary margins of delay and power consumption are reduced by characterizing a cell according to arrangement patterns of other cells adjacent to the cell on the layout. The characterization under the best condition and more effective reduction of the margins are achieved by intentionally generating a better arrangement pattern according to the preferred rule.

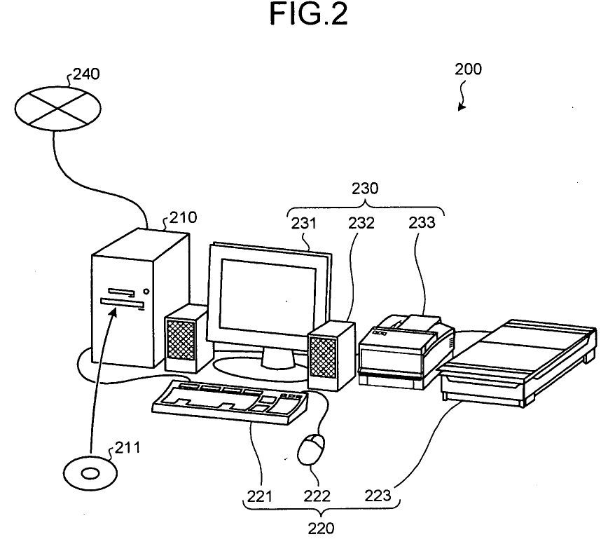

FIG. 2 is a schematic of a design support apparatus 200 according to the embodiment of the present invention. The design support apparatus 200 includes a computer 210, an input device 220, and an output device 230, and can be connected with a network 240 such as an LAN, a WAN, and the Internet through a non-depicted router or a modem.

The computer 210 includes a CPU, a memory, and an interface. The CPU controls the entire design support apparatus 200. The memory includes, for example, a read-only memory (ROM), a random access memory (RAM), a hard disk (HD), an optical disc 211, or a flash memory. The memory is used as a work area for the CPU.

Various programs are stored in the memory and loaded in response to a command from the CPU. The reading/writing of data from/into the HD and the optical disc 211 is controlled by a disk drive. The optical disc 211 and the flash memory are removable. The interface controls input from the input device 220, output to the output device 230, and transmission/reception with respect to the network 240.

As the input device 220, a keyboard 221, a mouse 222, and a scanner 223 are adopted. The keyboard 221 includes keys to input, for example, characters, numeric figures, and various kinds of instructions, and data is input through the keyboard 221. The keyboard 221 may be a touch panel type. The mouse 222 is used to move a cursor, select a range, move a window, or change a window size. The scanner 223 optically reads an image as image data, which is stored in the memory of the computer 210. The scanner 223 may have an optical character recognition (OCR) function.

As the output device 230, a display 231, a speaker 232, a printer 233, and others are adopted. The display 231 displays a cursor, an icon, or a tool box as well as data such as text, an image, and function information. The speaker 232 outputs sound such as a sound effect or a text-to-voice converted sound. The printer 233 prints image data or text data.

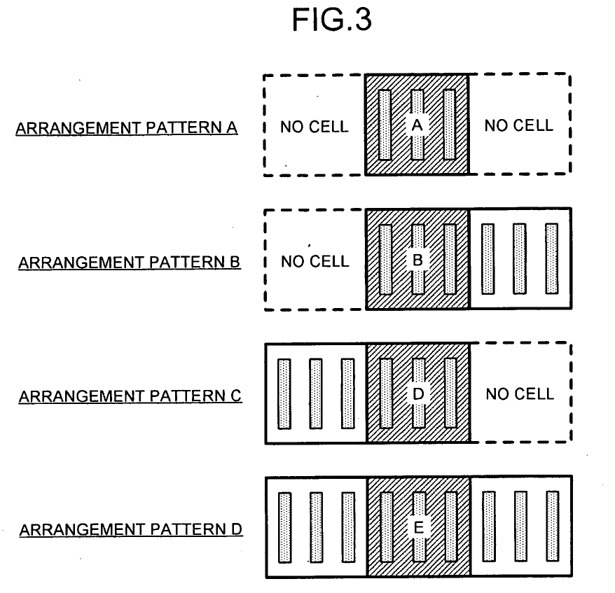

FIG. 3 is a schematic of arrangement patterns of other cells. Four arrangement patterns based on arrangement situations of other cells adjacent to a cell are shown. In this embodiment, available areas for arranging other cells are present on both the right and left sides of a cell.

An arrangement pattern A is a pattern in which no cell is arranged in the right and the left available areas. An arrangement pattern B is a pattern in which another cell is arranged in the right available area according to the preferred rule. An arrangement pattern D is a pattern in which another cell is arranged in the left available area according to the preferred rule. An arrangement pattern E is a pattern in which other cells are arranged in both the right and the left available areas according to the preferred rule.

Thus, the arrangement patterns of other cells adjacent to a cell on a layout of the design target circuit are classified into four patterns of patterns A, B, D, and E.

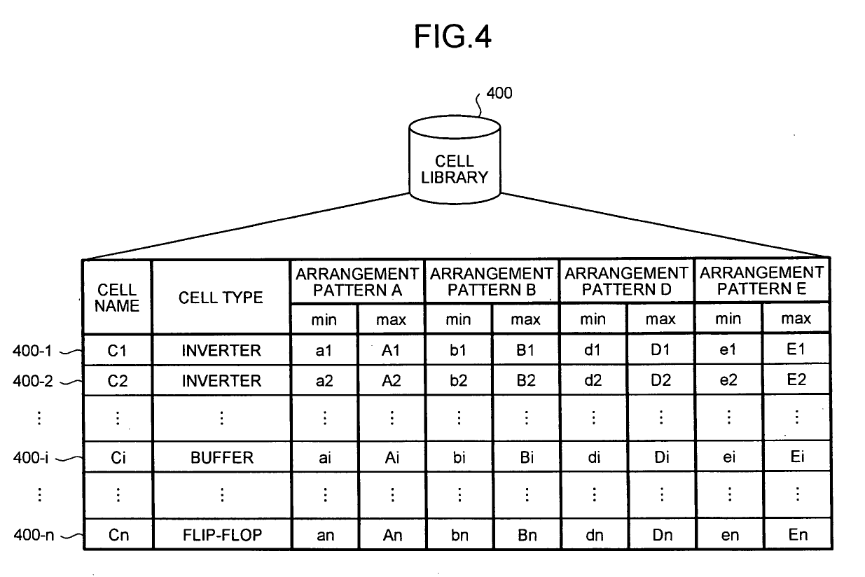

FIG. 4 is a schematic of a cell library 400. The cell library 400 includes delay information 400-1 to 400-n for cells C1 to Cn, respectively. Specifically, each of the delay information 400-1 to 400-n includes a cell name, a cell type, and plural delay values [min (minimum delay value), max (maximum delay value)] corresponding to the arrangement patterns A, B, D, and E shown in FIG. 3.

The cell name is a name of a cell. The cell type is information representing performance characteristics of a cell and represents, for example, a function (type) such as an inverter, a flip-flop, and a buffer. The delay values [min, max] are values indicating delay time of each cell actually used in the delay analysis for estimating the circuit delay of the design target circuit.

Taking a cell Ci as an example, the cell type is a buffer, and the delay values are delay values [ai, Ai] corresponding to the arrangement pattern A, delay values [bi, Bi] corresponding to the arrangement pattern B, delay values [di, Di] corresponding to the arrangement pattern D, and delay values [ei, Ei] corresponding to the arrangement pattern E.

The delay values of each cell in the library 400 can be calculated, for example, with the statistical static timing analysis (SSTA) technique, which is a known technology, by using conditions corresponding to the arrangement patterns of other cells.

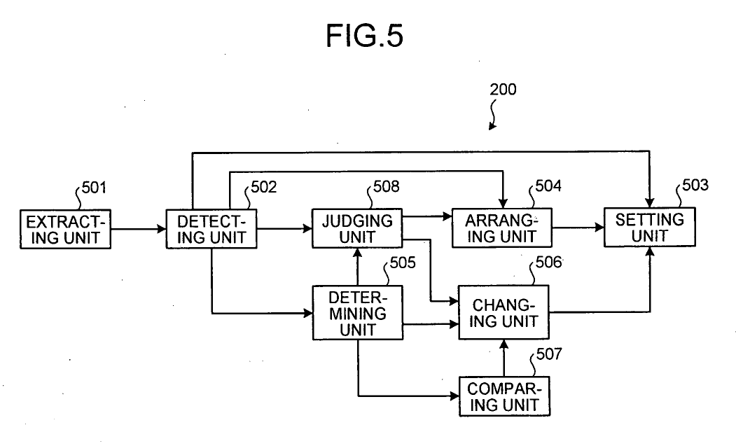

FIG. 5 is a block diagram of the design support apparatus 200. The design support apparatus 200 includes the cell library 400, an extracting unit 501, a detecting unit 502, a setting unit 503, an arranging unit 504, a determining unit 505, a changing unit 506, a comparing unit 507, and a judging unit 508.

The functions 501 to 508 can be implemented by the CPU executing programs related to the functions stored in a storage area. The output data from the functions 501 to 508 are retained in a storage area. A destination function pointed out by an arrow shown in FIG. 5 reads the output data of the source function from the storage area, and causes the CPU to execute the programs related to the function.

The extracting unit 501 extracts an arbitrary cell from the layout of the design target circuit in which cells including transistors are arranged. Specifically, arrangement information of an arbitrary cell is extracted from the layout information of the design target circuit. The layout information is information (e.g., a net list) indicating connection relationships of transistors and cells in the design target circuit. More specifically, arrangement information indicating the arrangement relationships between a cell and other cells adjacent to the cell is included.

The layout information may directly be input to the design support apparatus 200, or may be acquired from an external computer apparatus through the network 240. This input or acquired layout information (arrangement information) is stored in the storage area such as the ROM and the RAM.

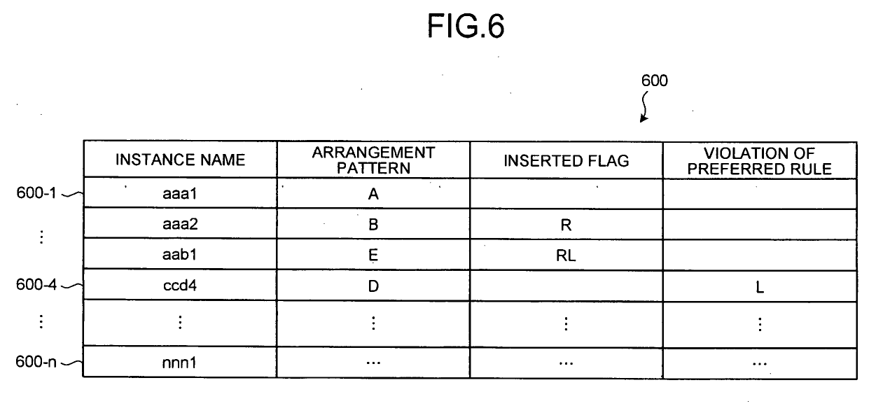

FIG. 6 is a schematic of the arrangement information. An arrangement information table 600 includes, for each cell (cell instance) arranged on the layout of the design target circuit, arrangement information 600-1 to 600-n indicating the arrangement relationship with other cells adjacent to the cell. The arrangement information table 600 is stored in the storage area such as the ROM and the RAM.

Specifically, the arrangement information 600-1 to 600-n includes an instance name, an arrangement pattern, an inserted flag, and information concerning preferred-rule violation. The instance name is a name of a cell arranged on the layout. The instance name can be used to identify a cell name and a cell type of a cell arranged on the layout.

The arrangement pattern indicates an arrangement situation of other cells adjacent to a cell. The inserted flag indicates an arrangement position (right: R, left: L) of a dummy transistor described hereinafter. The preferred-rule violation indicates an arrangement position (right: R, left: L) of a transistor violating the preferred rule.

Taking the arrangement information 600-1 as an example, it is indicated for a cell having an instance name “aaa1” that the arrangement pattern of other cells adjacent to the cell is the arrangement pattern A (see FIG. 3), and no dummy transistor is arranged on the right and the left.

Taking the arrangement information 600-4 as an example, it is indicated for a cell having an instance name “ccd4” that the arrangement pattern of other cells adjacent to the cell is the arrangement pattern D (see FIG. 3), no dummy transistor is arranged on the right and the left, and an interval with a transistor arranged on the left does not comply with the preferred rule.

Returning to FIG. 5, the detecting unit 502 detects another cell adjacent to the cell extracted by the extracting unit 501. Specifically, by referring to arrangement information of an arbitrary cell, an arrangement pattern of another cell adjacent to the cell may be detected. For example, when the arrangement information 600-4 of FIG. 6 is extracted, the arrangement pattern D is detected by referring to the arrangement information 600-4.

The setting unit 503 sets a delay value of a cell according to the arrangement pattern of other cells adjacent to the cell as a result of the detection by the detecting unit 502. Specifically, a delay value of an arbitrary cell is extracted from the cell library 400 (see FIG. 4) according to the arrangement pattern detected by the detecting unit 502 and set as the delay value of the cell (see a first example described hereinafter).

For example, if the arrangement pattern D is detected by referring to the arrangement information 600-4, a corresponding delay value is extracted from the cell library 400 using the cell name, the cell type, and the arrangement pattern D that are identified from the instance name “ccd4”, and the delay value is set as the delay value of the cell.

Thus, a delay value of an arbitrary cell arranged on the layout of the design target circuit can be set according to the arrangement patterns A, B, D, and E of other cells adjacent to the cell. As a result, characterization can be implemented for each cell under the condition corresponding to the arrangement patterns A, B, D, and E, thereby enabling reduction in the unnecessary margins of delay and power consumption.

The arranging unit 504 arranges, according to the design rule, a dummy transistor in an available area on the layout where another cell is not detected. Specifically, a dummy transistor is arranged in an available area adjacent to a cell according to the preferred rule prescribing the interval between transistors (see a second example described hereinafter).

Thus, with respect to an arbitrary cell arranged on the layout of the design target circuit, a dummy transistor can be arranged according to the preferred rule in an available area where another cell adjacent to the cell is not arranged. In other words, an arrangement pattern for implementing the characterization under better conditions can intentionally be generated by arranging the dummy transistor.

As a result of the detection by the detecting unit 502, the determining unit 505 determines whether a transistor in a cell and a transistor in another cell adjacent to the cell are arranged according to the design rule. In other words, under a situation that another cell is arranged adjacent to a cell, it is determined whether an interval between a transistor in the cell and a transistor in the adjacent cell complies with the preferred rule.

The changing unit 506 changes an arrangement position of the adjacent cell on the layout according to the design rule if the determining unit 505 determines that the design rule is violated. Specifically, if it is determined that an interval between a transistor in the cell and a transistor in the adjacent cell is narrower than is defined by the design rule, the cell and the adjacent cell may be spaced away (see a third example described hereinafter).

If it is determined that an interval between a transistor in the cell and a transistor in the adjacent cell is wider than is defined by the design rule, the cell and the adjacent cell may be spaced away, and a dummy transistor may be arranged between the cell and the adjacent cell (see a fourth example described hereinafter).

Thus, for an arbitrary cell arranged on the layout of the design target circuit, if a transistor in the cell and a transistor in another cell arranged adjacent to the cell are not arranged according to the preferred rule, the arrangement position of the adjacent cell can be changed according to the preferred rule.

The comparing unit 507 compares the increase in delay value caused by extension of a wiring length if the arrangement position of the adjacent cell is changed, and the decrease in delay value caused if a dummy transistor is arranged according to the design rule. Specifically, for example, the increase in delay value caused by extension of a wiring length is compared with the decrease in delay value caused if the cell and the adjacent cell are spaced away to arrange a dummy transistor therebetween.

In this comparison process, a delay analysis estimating the circuit delay may be performed before and after the change to compare the increase in delay value and the decrease in delay value using the respective analysis results. Alternatively, by focusing only on the changed portions, a delay value (increase) corresponding to an extended wiring length may be compared with a delay value (decrease) improved by changing the arrangement pattern.

The changing unit 506 may change the arrangement position of the adjacent cell if the decrease in delay value is greater than the increase in delay value as a result of the comparison by the comparing unit 507 (see a fifth example described hereinafter). In other words, whether the change process is executed by the changing unit 506 is determined in consideration of a trade-off between the increase and decrease in delay value before and after the change.

The judging unit 508 judges whether a wiring is present at the arrangement position of the dummy transistor. Specifically, for example, a position of a wiring on the layout is determined from a net list of the design target circuit to judge whether a wiring is present at the arrangement position of the dummy transistor (see a sixth example described hereinafter).

The arranging unit 504 may arrange a dummy transistor in an available area on the layout where an adjacent cell is not detected if the judging unit 508 judges that no wiring is present. The changing unit 506 may arrange a dummy transistor between a transistor in the cell and a transistor in the adjacent cell if the judging unit 508 judges that no wiring is present.

Thus, when a dummy transistor is arranged, if a wiring is present at the arrangement position of the dummy transistor, the wiring can be handled as the dummy transistor to prevent reduction of a wiring rate and to reduce processing required for arranging the unnecessary dummy transistor.

If the arrangement process of the arranging unit 504 and the changing process of the changing unit 506 are executed, the contents of the arrangement information concerning the cell (e.g., the arrangement information 600-1 to 600-n shown in FIG. 6) are updated. Specifically, if a dummy transistor is arranged adjacent to the cell, the contents indicating the arrangement position of the dummy transistor are updated.

If a dummy transistor is arranged and the arrangement pattern of the adjacent cells is changed, the contents indicating the arrangement situation of the adjacent cells are updated. If a preferred-rule violation is resolved, the contents indicating the arrangement position corresponding to the preferred-rule violation is updated.

Taking the arrangement information 600-4 shown in FIG. 6 as an example, if a dummy transistor is arranged in the available area on the right of the cell with the instance name “ccd4”, “R” is added to the field of the inserted flag, and the arrangement pattern is changed from the arrangement pattern D to the arrangement pattern E. If the preferred-rule violation on the left is resolved, “L” is deleted from the field of the preferred-rule violation.

The arranging unit 504 arranges a dummy transistor in the boundary area of the layout. In other words, a dummy transistor is preliminarily arranged in the boundary area of the layout to ensure the preferred rule on the left or right of a cell arranged along the outer circumference of the layout (see a seventh example described hereinafter). As a result, the characterization under better conditions can be implemented for a cell adjacent to the boundary area of the layout.

The setting unit 503 sets a delay value of a cell according to the arrangement pattern of other cells adjacent to the cell as a result of the arranging unit 504 arranging the dummy transistor. Specifically, a delay value of an arbitrary cell is extracted from the cell library 400 (see FIG. 4) according to the arrangement pattern after the dummy transistor is arranged by the arranging unit 504, and the value is set as the delay value of the cell.

The setting unit 503 also sets a delay value of a cell according to the arrangement pattern of other cells adjacent to the cell as a result of the changing unit 506 arranging the dummy transistor. A delay value of an arbitrary cell is extracted from the cell library 400 (see FIG. 4) according to the arrangement pattern after the dummy transistor is arranged by the changing unit 506, and the value is set as the delay value of the cell.

Thus, a delay value of an arbitrary cell arranged on the layout of the design target circuit can be set according to the arrangement patterns A, B, D, and E of other cells, which are changed along with the arrangement of the dummy transistor. As a result, the cell characterization under better conditions can be implemented to reduce the unnecessary margins of delay and power consumption.

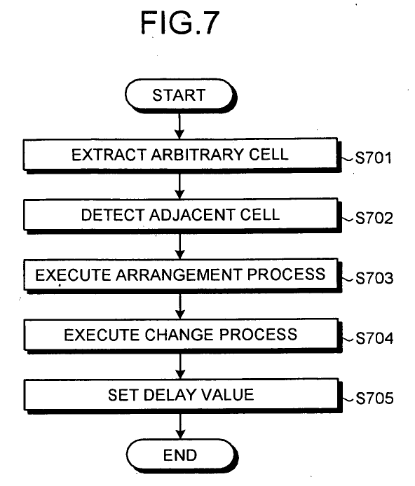

FIG. 7 is a flowchart of a design support process executed by the design support apparatus 200. The extracting unit 501 extracts an arbitrary cell from a layout of a design target circuit on which cells including transistors are arranged (step S701). The detecting unit 502 detects another cell adjacent to the cell extracted by the extracting unit 501 (step S702).

The arranging unit 504 executes the arrangement process of arranging a dummy transistor in an available area on the layout where another cell is not detected (step S703). The changing unit 506 executes the change process of changing the arrangement position of the adjacent cell on the layout according to the design rule (step S704).

The setting unit 503 sets the delay value of the cell according to the arrangement pattern of the adjacent cell (step S705), and a series of processing ends. The processing at steps S703 and S704 may be executed in reverse order or may concurrently be executed.

According to the embodiments of the present invention described above, a delay value of an arbitrary cell arranged on the layout of the design target circuit can be set according to the arrangement patterns A, B, D, and E of other cells adjacent to the cell. As a result, the cell characterization can be implemented under the condition corresponding to the arrangement patterns A, B, D, and E to reduce the unnecessary margins of delay and power consumption.

For an arbitrary cell arranged on the layout of the design target circuit, a dummy transistor can be arranged according to the preferred rule in an available area where another cell is not arranged adjacent to the cell. If a transistor in the cell and a transistor in the adjacent cell are not arranged according to the preferred rule, the arrangement position of the adjacent cell can be changed according to the preferred rule.

Thus, the arrangement pattern implementing the cell characterization under better conditions can intentionally be generated by arranging the dummy transistor according to the preferred rule. The cell characterization under better conditions can also be implemented by setting the delay value of the cell according to the intentionally generated arrangement patterns A, B, D, and E to reduce the unnecessary margins of delay and power consumption.

The increase and decrease in delay value after the change in the arrangement pattern can be compared to determine whether the arrangement pattern is to be changed. Therefore, the cell characterization under better conditions can be implemented in consideration of a trade-off between the increase and decrease in delay value.

When a dummy transistor is arranged, if a wiring is present at the arrangement position of the dummy transistor, the wiring can be handled as the dummy transistor to prevent reduction of a wiring rate and to reduce processing required for arranging the unnecessary dummy transistor.

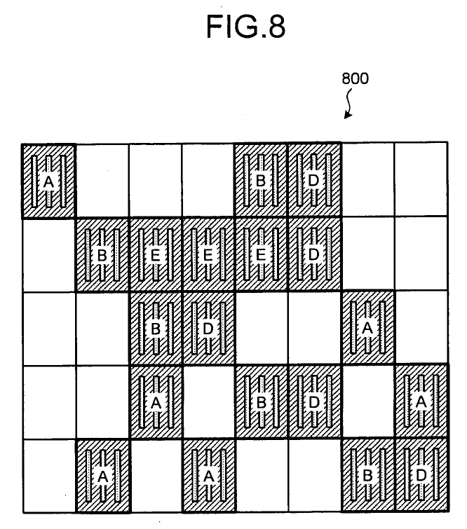

FIG. 8 is a first schematic of a layout 800 of the design target circuit. Plural cells including transistors are arranged on the layout 800 of the design target circuit. Arrangement patterns A, B, D, and E are added to the cells based on the arrangement situations of adjacent cells.

In the first example, when estimating the circuit delay of the design target circuit, a delay value of a cell used for the delay analysis are selectively used according to the arrangement patterns A, B, D, and E of other cells adjacent to the cell.

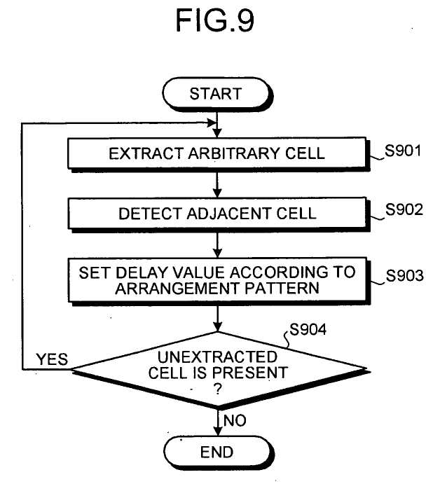

FIG. 9 is a flowchart of a design support process of the first example. The extracting unit 501 extracts an arbitrary cell from the layout of the design target circuit on which cells including transistors are arranged (step S901), and the detecting unit 502 detects another cell adjacent to the cell (step S902).

The setting unit 503 extracts the delay value of the cell from the cell library 400 according to the arrangement pattern of the adjacent cell as a result of the detection by the detecting unit 502, and sets the delay value as the delay value of the cell extracted at step S901 (step S903).

It is determined whether an unextracted cell is present among the cells in the layout 800 (step S904), and if an unextracted cell is present (step S904: YES), the process returns to step S901 to repeat a series of processing. On the other hand, if no unextracted cell is present (step S904: NO), a series of processing ends.

Specifically, for example, the arrangement information 600-1 to 600-n shown in FIG. 6 is sequentially extracted, and above steps S901 to S904 are repeatedly executed until when the unextracted arrangement information 600-1 to 600-n is not present.

According to the first example, the delay value of the cell in the layout 800 can be set according to the arrangement patterns A, B, D, and E of the other cells adjacent to the cell. Therefore, when the circuit delay of the design target circuit is estimated, the delay analysis can be performed using appropriate delay values according to the conditions (such as the worst condition and the best condition) of the cells, and the unnecessary margin of delay can be reduced.

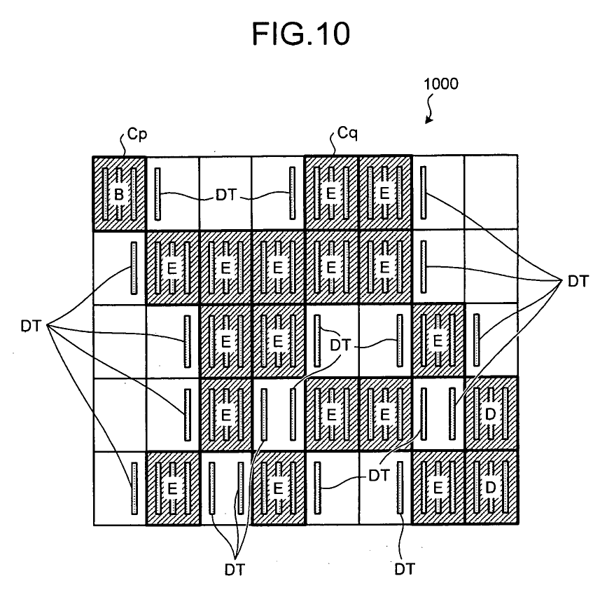

In the second example, the cell characterization under better conditions is implemented by arranging the dummy transistors in the available areas where other cells are not arranged adjacent to cells on the layout. FIG. 10 is a second schematic of a layout 1000 of the design target circuit.

Dummy transistors DT are arranged on the layout 1000 according to the preferred rule in the available areas where other cells are not arranged adjacent to cells. As a result, for some cells in the layout 800 shown in FIG. 8, the arrangement patterns of other cells adjacent to the cells are changed.

For example, in the case of a cell Cp, since the dummy transistor DT is arranged in the right available area, the arrangement pattern is changed from the arrangement pattern A to the arrangement pattern B. In the case of a cell Cq, since the dummy transistor DT is arranged in the left available area, the arrangement pattern is changed from the arrangement pattern B to the arrangement pattern E.

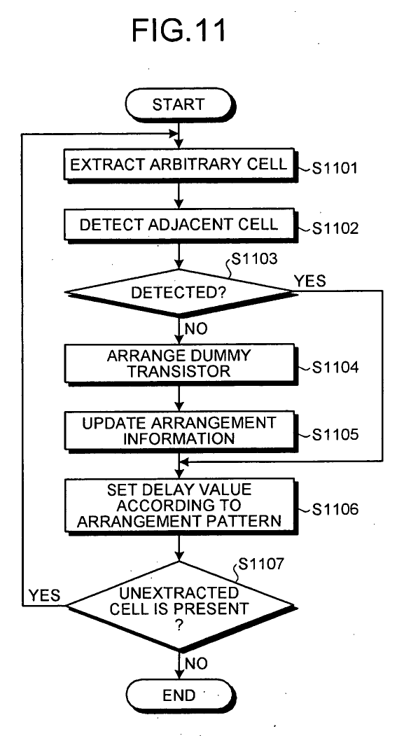

FIG. 11 is a flowchart of a design support process of the second embodiment. The extracting unit 501 extracts an arbitrary cell from the layout of the design target circuit on which cells including transistors are arranged (step S1101), and the detecting unit 502 detects another cell adjacent to the cell (step S1102).

It is determined whether the adjacent cell is detected (step S1103), and if the adjacent cell is not detected (step S1103: NO), the arranging unit 504 arranges the dummy transistor DT in the available area on the layout where the adjacent cell is not detected (step S1104).

The arrangement information is updated based on the arrangement of the dummy transistor DT (step S1105), and the setting unit 503 extracts the delay value of the cell from the cell library 400 according to the arrangement pattern of another cell adjacent to the cell as a result of the arranging unit 504 arranging the dummy transistor DT, and sets the delay value as the delay value of the cell extracted at step S1101 (step S1106).

It is determined whether an unextracted cell is present among the cells of the layout 1000 (step S1107), and if an unextracted cell is present (step S1107: YES), the process returns to step S1101 to repeat a series of processing. On the other hand, if no unextracted cell is present (step S1107: NO), a series of processing ends. If the adjacent cell is detected at step S1103 (step S1103: YES), the process proceeds to step S1106.

According to the second example, the dummy transistor DT can be arranged in an available area on the layout where another cell is not arranged adjacent to the cell. Therefore, the cell characterization under better conditions is implemented, and the unnecessary margin of delay can be reduced when estimating the circuit delay of the design target circuit.

In the third example, if a transistor in a cell and a transistor in another cell arranged adjacent to the cell are not arranged according to the design rule, the arrangement position of the adjacent cell is changed to implement the cell characterization under better conditions.

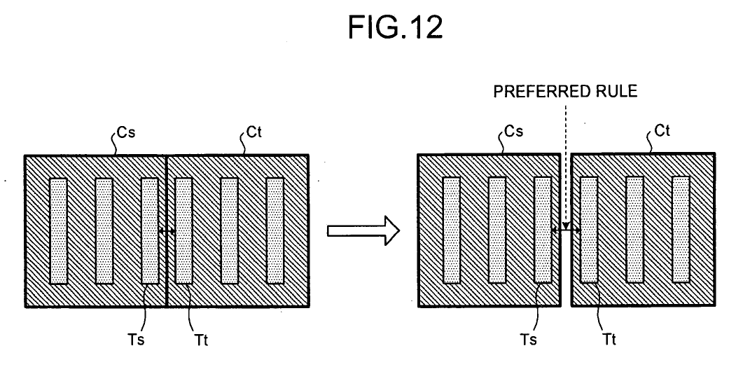

FIG. 12 is a first schematic of the change process executed by the changing unit 506. A cell Ct is arranged adjacent to a cell Cs. However, an interval between a transistor Ts in the cell Cs and a transistor Tt in the cell Ct does not comply with the preferred rule. Therefore, the arrangement position of the transistor Tt is changed by spacing away the cell Cs and the cell Ct accordance to the preferred rule.

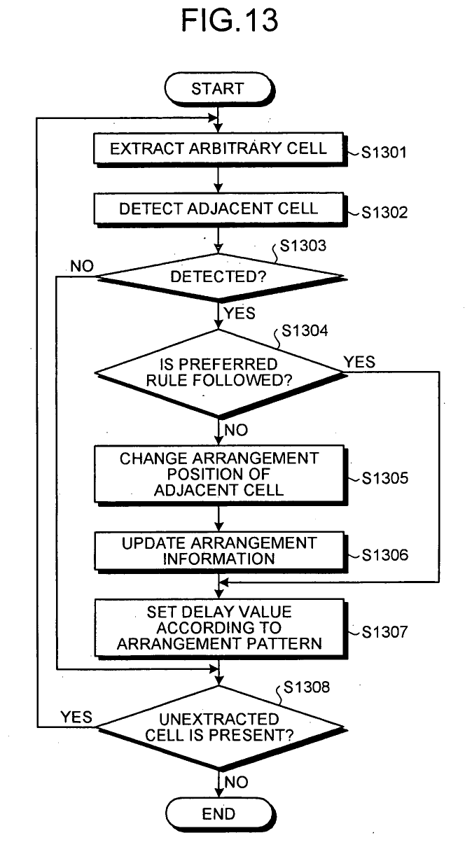

FIG. 13 is a flowchart of a design support process of the third embodiment. The extracting unit 501 extracts an arbitrary cell from the layout of the design target circuit (step S1301), and the detecting unit 502 detects another cell adjacent to the cell (step S1302).

It is then determined whether the adjacent cell is detected (step S1303), and if the adjacent cell is detected (step S1303: YES), the determining unit 505 determines whether a transistor in the cell and a transistor in the adjacent cell are arranged according to the preferred rule (step S1304).

If it is determined that an interval between the transistor in the cell and the transistor in the adjacent cell is narrower than the interval defined by the preferred rule (step S1304: NO), the cell and the adjacent cell is spaced away by the changing unit 506 according to the preferred rule to change the arrangement position of the adjacent cell on the layout (step S1305).

The arrangement information is updated based on the arrangement position of the adjacent cell (step S1306), and the setting unit 503 extracts the delay value of the cell from the cell library 400 according to the arrangement pattern of the adjacent cell as a result of the changing unit 506 changing the arrangement position of the adjacent cell, and sets the delay value as the delay value of the cell extracted at step S1301 (step S1307).

It is then determined whether an unextracted cell is present among the cells in the layout (step S1308), and if an unextracted cell is present (step S1308: YES), the process returns to step S1301 to repeat a series of processing. On the other hand, if no unextracted cell is present (step S1308: NO), a series of processing ends.

If the adjacent cell is not detected at step S1303 (step S1303: NO), the process returns to step S1308. If it is determined that the preferred rule is followed at step S1304 (step S1304: YES), the process proceeds to step S1307.

According to the third embodiment, even when another cell is arranged adjacent to a cell, if the preferred rule is violated (the interval between transistors is narrower), the cell and the adjacent cell can be spaced away. Therefore, since the interval between the transistors is corrected to the interval defined by the preferred rule, the cell characterization under better conditions is implemented, and the unnecessary margin of delay can be reduced when the circuit delay of the design target circuit is estimated.

In the fourth example, if a transistor in a cell and a transistor in another cell arranged adjacent to the cell are not arranged according to the preferred rule, the arrangement position of the adjacent cell is changed, and the dummy transistor DT is arranged between the cell and the adjacent cell to implement the cell characterization under better conditions.

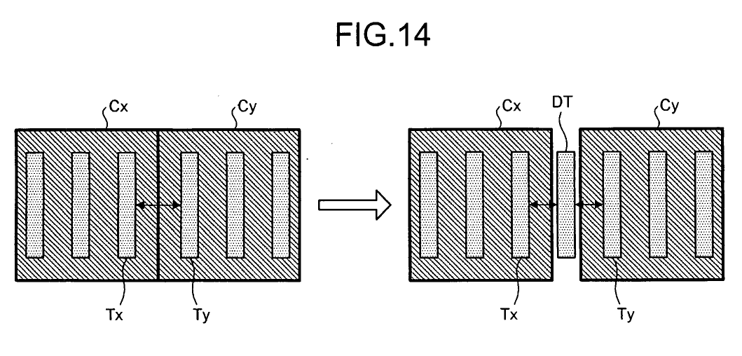

FIG. 14 is a second schematic of the change process performed by the changing unit 506. A cell Cy is arranged adjacent to a cell Cx. However, an interval between a transistor Tx in the cell Cx and a transistor Ty in the cell Cy is too wide and does not comply with the preferred rule.

Therefore, the cell Cx and the cell Cy are spaced away to form an available area between the cell Cx and the cell Cy. The dummy transistor DT is then arranged in the available area according to the preferred rule.

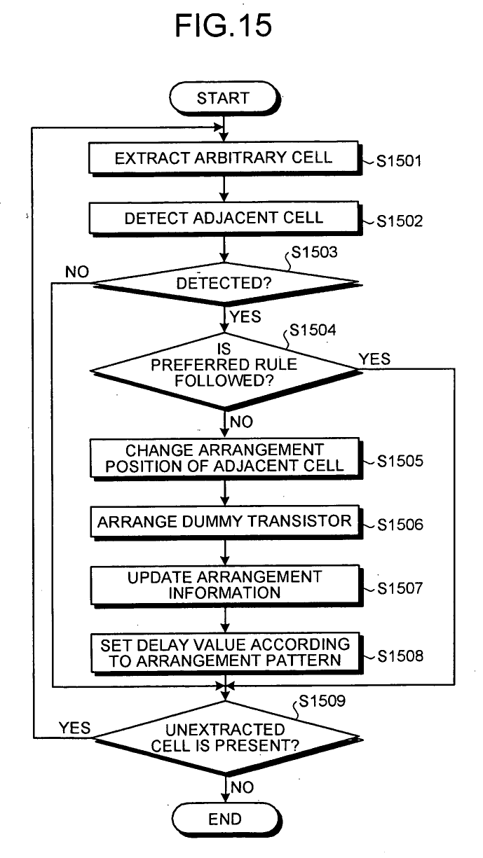

FIG. 15 is a flowchart of a design support process of the fourth embodiment. The extracting unit 501 extracts an arbitrary cell from the layout of the design target circuit (step S1501), and the detecting unit 502 detects another cell adjacent to the cell (step S1502).

It is then determined whether the adjacent cell is detected (step S1503), and if the adjacent cell is detected (step S1503: YES), the determining unit 505 determines whether a transistor in the cell and a transistor in the adjacent cell are arranged according to the preferred rule (step S1504).

If it is determined that an interval between the transistor in the cell and the transistor in the adjacent cell is wider than is defined by the preferred rule (step S1504: NO), the cell and the adjacent cell are spaced away by the changing unit 506 according to the preferred rule to change the arrangement position of the adjacent cell on the layout (step S1505), and the dummy transistor DT is then arranged between the transistor in the cell and the transistor in the adjacent cell (step S1506).

The arrangement information is then updated based on the arrangement positions of the adjacent cell and the dummy transistor (step S1507), and the setting unit 503 extracts the delay value of the cell from the cell library 400 according to the arrangement pattern of the adjacent cell as a result of the changing unit 506 arranging the dummy transistor DT, and sets the delay value as the delay value of the cell extracted at step S1501 (step S1508).

It is then determined whether an unextracted cell is present among the cells in the layout (step S1509), and if an unextracted cell is present (step S1509: YES), the process returns to step S1501 to repeat a series of processing. On the other hand, if no unextracted cell is present (step S1509: NO), a series of processing ends.

If the adjacent cell is not detected at step S1503 (step S1503: NO), the process proceeds to step S1509. If it is determined at step S1504 that the transistors comply with the preferred rule (step S1504: YES), the process proceeds to step S1509.

According to the fourth example, even when another cell is arranged adjacent to a cell, if the preferred rule is violated (the interval between transistors is wider), the cell and the adjacent cell can be spaced away, and the dummy transistor DT can be arranged in the available area between the cell and the adjacent cell.

Therefore, since the interval between the transistors is corrected to the interval defined by the preferred rule, the cell characterization under better conditions is implemented, and the unnecessary margin of delay can be reduced when the circuit delay of the design target circuit is estimated.

In the fifth example, when the arrangement position of the adjacent cell shown in the third and fourth examples is changed, the cell characterization is implemented under better conditions in consideration of a trade-off between the increase in delay value caused by spacing away the cell and the adjacent cell, and the decrease in delay value caused by eliminating a design rule violation.

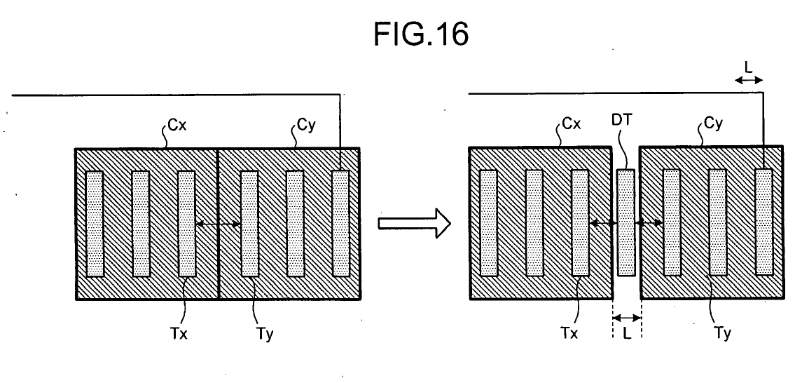

FIG. 16 is a schematic illustrating extension of a wiring length caused by a change in an arrangement position. The cell Cx and the cell Cy are spaced away due to the preferred-rule violation, and the dummy transistor DT is arranged between the transistor Tx in the cell Cx and the transistor Ty in the cell Cy. As a result, the delay dependent on characterization of the cells can be reduced.

On the other hand, along with this change, the wiring length is extended by a distance L by which the adjacent cell Cy is spaced away. As a result, the delay dependent on the wiring length L is increased. Therefore, when the changing unit 506 executes the change process, a trade-off between the decrease in delay value dependent on the characterization and the increase in delay value caused by the extension of the wiring is considered.

Specifically, results of delay analysis for a path including the cell Cx and the adjacent cell Cy before and after the change by the changing unit 506 may be compared. Alternatively, the decrease in delay value dependent on the characterization of the cell Cx and the adjacent cell Cy may be compared with the delay value of the wiring of the wiring length L. Only when the decrease in delay value is greater as a result, the changing unit 506 executes the change process.

According to the fifth example, the changing unit 506 can execute the change process in consideration of the trade-off between the increase in delay value caused by the extension of the wiring length, and the decrease in delay value caused by eliminating the preferred-rule violation. Therefore, the cell characterization under better conditions is implemented in consideration of the trade-off between the increase and decrease in delay value, and the unnecessary margin of delay can be reduced when the circuit delay of the design target circuit is estimated.

In the sixth example, when the dummy transistor DT is arranged according to the preferred rule, if a wiring is present at the arrangement position thereof, the wiring is handled as the dummy transistor DT to prevent reduction of a wiring rate and to reduce processing required for arranging the unnecessary dummy transistor DT.

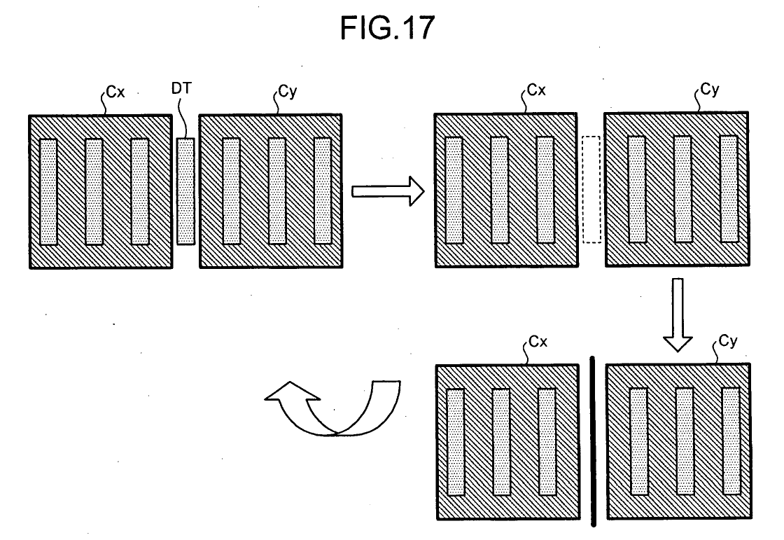

FIG. 17 is a schematic of the process of arranging the dummy transistor according to presence of a wiring. The dummy transistor DT is arranged according to the preferred rule between the cell Cx and the cell Cy on the layout of the design target circuit. When the wiring is subsequently performed on the layout, the arrangement position of the dummy transistor DT is recorded, and the dummy transistor DT is deleted from the layout.

It is then judged whether a wiring pattern is present at the position where the dummy transistor DT has been arranged. If a wiring pattern is present, the dummy transistor DT is not arranged, and if no wiring pattern is present, the dummy transistor DT is arranged again.

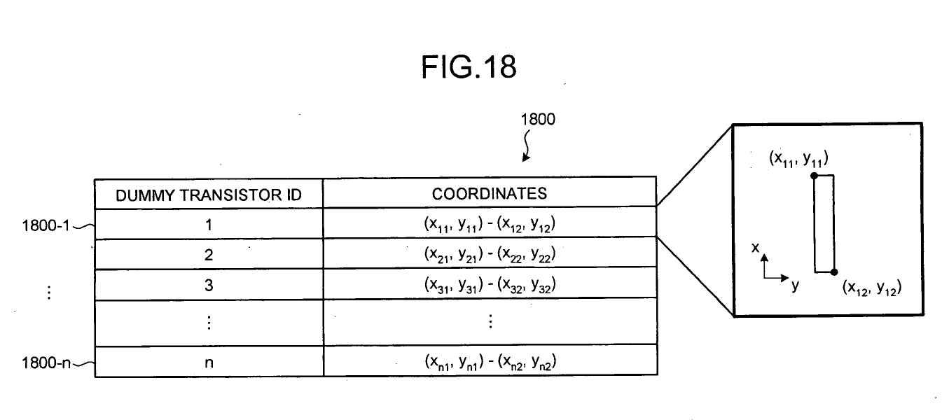

FIG. 18 is a schematic of an arrangement position table storing the arrangement positions of the dummy transistors DT. An arrangement position table 1800 includes dummy transistor information 1800-1 to 1800-n representing an arrangement position of each of the transistors DT on the layout.

Specifically, each of the dummy transistor information 1800-1 to 1800-n includes a dummy transistor ID that identifies the dummy transistor DT, and coordinates (x, y) indicating an arrangement position of the dummy transistor DT. The coordinates (x, y) indicates diagonal positions of vertices of the dummy transistor DT on a coordinate plane representing the layout.

For example, the dummy transistor information 1800-1 includes coordinates (x₁₁, y₁₁)-(x₁₂, Y₁₂) indicating the arrangement position of the dummy transistor DT identified by a dummy transistor ID “1”. The arrangement position table 1800 is stored in the storage area such as the ROM and the RAM.

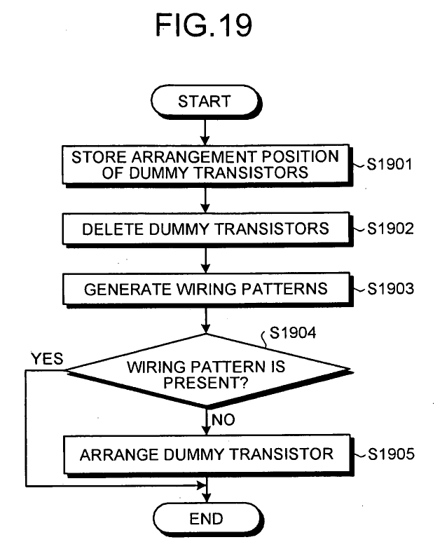

FIG. 19 is a flowchart of a design support process of the sixth embodiment. A process until the dummy transistor DT is arranged is be shown and described. The arrangement positions of the dummy transistors DT arranged on the layout are stored in the arrangement position table 1800 (step S1901).

The dummy transistors DT arranged on the layout are deleted (step S1902). Wiring patterns are then generated on the layout based on the net list of the design target circuit (step S1903). The judging unit 508 reads the arrangement position table 1800 from the storage area, and refers to the arrangement position table 1800 to judge whether a wiring pattern is present at the position where the dummy transistor DT has been arranged (step S1904).

If no wiring pattern is present (step S1904: NO), the dummy transistor DT is arranged at the arrangement position (step S1905), a series of processing ends. On the other hand, if a wiring pattern is present at step S1904 (step S1904: YES), a series of processing ends.

According to the sixth example, when the dummy transistor DT is arranged according to the preferred rule, the dummy transistor DT can be arranged depending on presence of a wiring at the arrangement position of the dummy transistor DT to prevent the reduction of the wiring rate and to reduce the processing required for arranging the unnecessary dummy transistor DT.

In the seventh example, the dummy transistors DT are arranged according to the preferred rule in the boundary area of the layout of the design target circuit to ensure the preferred rule on the left or right of cells arranged along the outer circumference of the layout and to implement the cell characterization under better conditions.

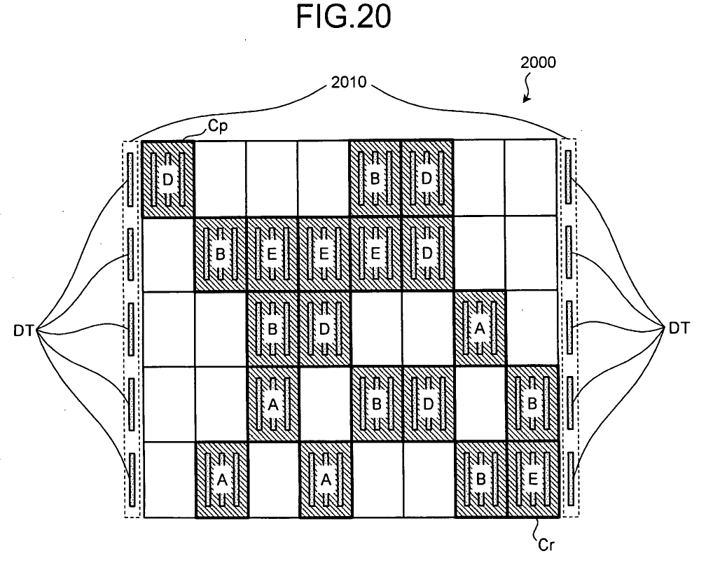

FIG. 20 is a third schematic of a layout 2000 of the design target circuit. The dummy transistors DT are arranged in boundary areas 2010 of the layout 2000. As a result, with regard to a cell Cp, the preferred rule is ensured on the left of the cell Cp, and the cell Cp can be characterized under better conditions.

With regard to a cell Cr, the preferred rule is ensured on the right of the cell Cr, and the cell Cr can be characterized under better conditions. The dummy transistors DT may be arranged on the boundary areas before arrangement/wiring is performed on the layout or may be arranged after arrangement/wiring is performed on the layout.

When the dummy transistors DT are arranged after arrangement/wiring is performed on the layout, the dummy transistors DT may be arranged only in the boundary areas adjacent to the cells arranged along the outer circumference of the layout.

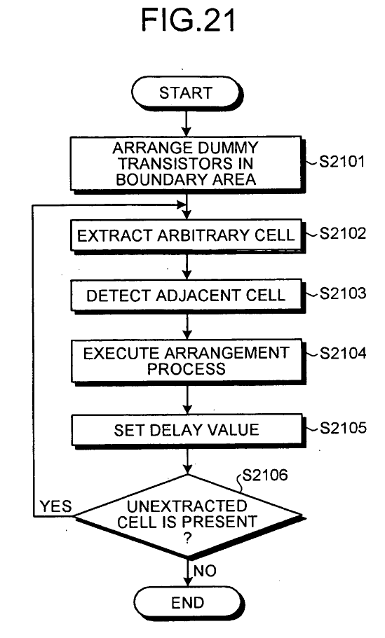

FIG. 21 is a flowchart of a design support process of the seventh example. An arrangement process at step S2104 described hereinafter will not be described in detail since the process is the same as is described in the second example. The arranging unit 504 arranges the dummy transistors DT in the boundary areas of the layout of the design target circuit (step S2101). The extracting unit 501 then extracts an arbitrary cell from the layout of the design target circuit (step S2102).

The detecting unit 502 detects another cell adjacent to the cell extracted by the extracting unit 501 (step S2103). The arranging unit 504 then arranges the dummy transistor DT in the available area on the layout where the adjacent cell is not detected (step S2104).

The setting unit 503 extracts the delay value of the cell from the cell library 400 according to the arrangement pattern of the adjacent cell (the arrangement pattern E in all cases), and sets the delay value as the delay value of the cell extracted at step S2102 (step S2105).

It is then determined whether an unextracted cell is present among the cells of the layout (step S2106), and if an unextracted cell is present (step S2106: YES), the process returns to step S2102 to repeat a series of processing. On the other hand, if no unextracted cell is present (step S2106: NO), a series of processing ends.

According to the seventh example, the dummy transistors DT can be arranged in the boundary areas of the layout to ensure the preferred rule on the left or right of the cells arranged along the outer circumference of the layout. The dummy transistors DT can be arranged in the available areas where an adjacent cell is not arranged.

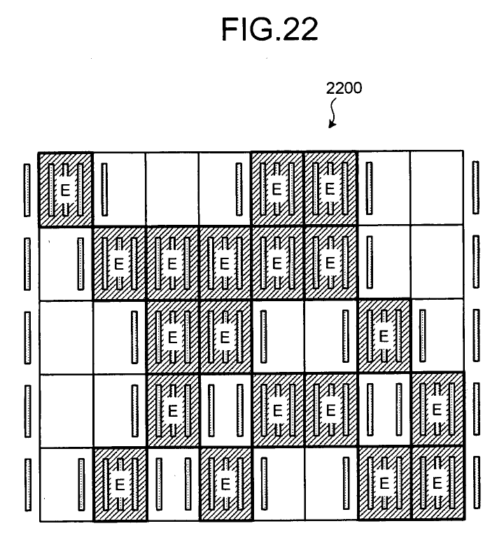

As a result, the arrangement patterns of other cells adjacent to all the cells arranged on the layout can be changed to the arrangement pattern E shown in FIG. 3. FIG. 22 is a fourth schematic of a layout 2200 of the design target circuit. The arrangement patterns of other cells adjacent to all the cells on the layout 2200 are the arrangement pattern E.

Therefore, all the cells on the layout can be characterized under the best condition to reduce the unnecessary margin of delay when the circuit delay of the design target circuit is estimated. The unnecessary margin of delay can be reduced, and the yield can be improved by manufacturing semiconductor integrated circuits using the architecture with the dummy transistors preliminarily arranged in the boundary areas on the layout shown in FIG. 20.

As explained above, according to the design support method and apparatus, and the computer product of the present invention, a delay value of an arbitrary cell arranged on a layout of a design target circuit can be set according to arrangement patterns of other cells adjacent to the cell.

Additionally, a dummy transistor can be arranged in an available area on the layout where the adjacent cell is not arranged.

Furthermore, a transistor in the arbitrary cell and a transistor in the adjacent cell can be arranged according to a design rule.

Moreover, an arrangement position of the adjacent cell can be changed in consideration of increase in delay value caused by extension of a wiring length and decrease in delay value caused by eliminating a design rule violation.

Additionally, among available areas where an adjacent cell is not arranged, a dummy transistor can be arranged only in an available area where a wiring is not present.

Furthermore, the design rule can be ensured for a cell adjacent to a layout boundary area.

Moreover, a delay value of the arbitrary cell can be set according to an arrangement pattern of the adjacent cell that is changed along with arrangement of a dummy transistor.

According to the computer product and the semiconductor integrated circuit of the present invention, a yield of the semiconductor integrated circuit can be improved.

Therefore, the optimization of timing design can effectively be achieved to reduce the burden of designers and the design period by reducing an unnecessary margin dependent on characterization of a cell.

With regard to design data concerning the design target circuit with the dummy transistors arranged according to the design rule in the available areas adjacent to cells including transistors described in the embodiments are recorded on a computer-readable recording medium, and read from the recording medium and used by a computer.

The design support apparatus 200 described in the embodiments can also be implemented by an integrated circuit (IC) for a specific use such as a standard cell or structured application specific integrated circuit (ASIC), and a programmable logic device (PLD) such as a field programmable gate array (FPGA). Specifically, for example, the above functional elements 501 to 508 of the design support apparatus 200 can be functionally defined by HDL description, and the HDL description can logically be synthesized and applied to the ASIC and the PLD to manufacture the design support apparatus 200.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A computer-readable recording medium that stores therein a design support program causing a computer to execute:
extracting a first cell from among a plurality of cells in a target circuit;
detecting a second cell arranged adjacent to the first cell; and
setting a delay value of the first cell according to an arrangement pattern of the second cell.

2. The computer-readable recording medium according to claim 1, wherein the design support program further causes the computer to execute
arranging a dummy transistor according to a design rule in an available area where the second cell is not detected at the detecting.

3. The computer-readable recording medium according to claim 1, wherein the design support program further causes the computer to execute
determining, after the detecting, whether a first transistor in the first cell and a second transistor in the second cell are arranged according to a design rule, and
changing a position of the second cell according to the design rule when it is determined at the determining that the first transistor and the second transistor are not arranged according to the design rule.

4. The computer-readable recording medium according to claim 3, wherein the changing includes spacing away the first cell and the second cell when it is determined at the determining that an interval between the first transistor and the second transistor is narrower than is determined by the design rule.

5. The computer-readable recording medium according to claim 3, wherein the changing includes spacing away the first cell and the second cell, and arranging a dummy transistor between the first cell and the second cell when it is determined at the determining that an interval between the first transistor and the second transistor is wider than is determined by the design rule.

6. The computer-readable recording medium according to claim 5, wherein the design support program further causes the computer to execute
comparing increase in the delay value caused by extension of a wiring length if the position of the second cell is changed at the changing, and decrease in the delay value if the dummy transistor is arranged at the arranging, and
the position of the second cell is changed according to the design rule at the changing when the decrease is greater than the increase as a result at the comparing.

7. The computer-readable recording medium according to claim 2, wherein the design support program further causes the computer to execute
judging whether a wiring is present at a position of the dummy transistor to be arranged, and
the dummy transistor is arranged in the available area at the arranging when it is determined at the judging that the wiring is not present.

8. The computer-readable recording medium according to claim 5, wherein the design support program further causes the computer to execute
judging whether a wiring is present at a position of the dummy transistor to be arranged, and
the dummy transistor is arranged between the first transistor and the second transistor at the changing when it is determined at the judging that the wiring is not present.

9. The computer-readable recording medium according to claim 2, wherein the dummy transistor is arranged in a boundary area of the target circuit.

10. The computer-readable recording medium according to claim 2, wherein the delay value of the first cell is set at the setting according to the arrangement pattern of the second cell after the dummy transistor is arranged.

11. The computer-readable recording medium according to claim 3, wherein the delay value of the first cell is set at the setting according to the arrangement pattern of the second cell after the dummy transistor is arranged.

12. A computer-readable recording medium storing therein design data concerning a target circuit including a dummy transistor arranged in an available area adjacent to a cell including a transistor.

13. A semiconductor integrated circuit including a dummy transistor arranged in an area adjacent to a cell including a transistor.

14. A design support apparatus comprising:
an extracting unit that extracts a first cell from among a plurality of cells in a target circuit;
a detecting unit that detects a second cell arranged adjacent to the first cell; and
a setting unit that sets a delay value of the first cell according to an arrangement pattern of the second cell.

15. A design support method comprising:
extracting a first cell from among a plurality of cells in a target circuit;
detecting a second cell arranged adjacent to the first cell; and
setting a delay value of the first cell according to an arrangement pattern of the second cell.
